(19) United States
(12) Patent Application Publication
(10) Pub. No.: US 2009/0282396 A1
(43) Pub. Date: Nov. 12, 2009

(54) PRESERVING A STATE OF AN APPLICATION DURING UPDATE

(76) Inventors: John M. Boyer, Victoria (CA); Eric Dunn, Victoria (CA); Sarah R. Pugh, Victoria (CA); Braam P. Smith, Willoughby (AU)

Correspondence Address: HOFFMAN WARNICK LLC, 75 STATE ST, 14TH FLOOR, ALBANY, NY, 12207, US

(21) Appl. No.: 12/116,369

(22) Filed: May 7, 2008

(51) Int. Cl. G06F 9/44

(52) U.S. Cl. 717/170

(57) ABSTRACT

The present invention augments an application update with an automatic sequence of steps for instantiating the updated application in place of the currently running application, without unintended loss of the end-user generated data that comprises all or part of the current application state. The new version may consume most or all of the previously entered data to enter a state of needing a minimal amount of new information (which may be different from being in the state of ready to submit).

### FIELD OF THE INVENTION

The present invention generally relates to application updating. Specifically, the present invention relates to the preservation of a state of an application during update of the application.

### BACKGROUND OF THE INVENTION

Many applications require large and complex multi-page electronic forms to guide a user through the maze of a branching form filling experience. It is often necessary to deliver these applications via a document-centric architecture, (i.e., as a single document). One important reason for using a document-centric architecture is to service users who are expected to be disconnected from the Internet during the fill experience. Another reason is to serve users who must perform an ad hoc workflow via email or similar means to collaboratively create the data content for the application. Such applications are capable of crossing enterprise and administrative domains to accomplish a task. Finally, a document-centric architecture is also frequently preferred by application developers and end-users alike for ease of development, deployment, maintenance, versioning and end-user experience.

One problem that arises with delivering document-centric applications to end-users is that the document application may be updated by the application provider during the time that the end-user has been disconnected, e.g., enjoying the benefits of the offline fill/save/reload experience. End-users would like to be able to take advantage of updates to the application presentation layer, data schema and business rules, particularly before submission of the final completed document. While application update capabilities are a common occurrence for imperative applications, the result of these updates is typically a restart, reboot or other operation that is only capable of preserving an initial start state or trivial rest state for the application. However, in a document-centric application, the application may be in an arbitrary state selected through user interaction, and the user expectation on application update is to have automatic transition to the new application and selection of an appropriate application state based on the user interactions with the prior version of the application.

### SUMMARY OF THE INVENTION

In general, the present invention augments an application update with an automatic sequence of steps for instantiating the updated application in place of the currently running application without unintended loss of the end-user generated data that comprises part or all of the current application state. One advantage is that the end-user does not have to repeat a complex fill experience that has already been performed with a prior version of the same application. Particularly, when application updates involve better help information or business rules that are not applicable to the particular end-user, the requirement to repeat the fill experience is frustrating and therefore deemed intolerable from a user experience standpoint. Moreover, in some cases when business rules (e.g., data validation constraints or changes of schema) are applicable to the portion of application being consumed by the end-user, most, if not all, of the data supplied by the user is still relevant and simply causes the updated application to enter the most desirable state. For example, based on updated taxation rules, end-user data that was deemed sufficient in the earlier application may be incomplete in the new version of the application. The new version may consume most or all of the previously entered data to enter a state of needing a minimal amount of new information (which may be different from being in the state of ready to submit).

A first aspect of the present invention provides a computer-implemented method for preserving a state of an application during update, comprising: providing an initial document template tagged by a name and a version number to represent an initial state of the application; instantiating the application by providing a user with a copy of the initial document template, the instantiating yielding an instantiated document; allowing the user to interact with the instantiated document; performing a check for updates of the application; updating the application if the currently instantiated document application version is not a latest available version of the application, as follows: obtaining a latest version of the initial document template, obtaining a transformation description for converting end-user data in the instantiated document to an updated schema format, if an end-user data schema of the application has been changed, creating a newly instantiated document on the latest version of the initial document template, transforming the end-user data using the transformation description if one was given, placing the end-user data or transformed end-user data into the newly instantiated document, and replacing the instantiated document with the new instantiated document in the end-user experience.

A second aspect of the present invention provides a system for preserving a state of an application during update, comprising: providing an initial document template tagged by a name and a version number to represent an initial state of the application; a module for instantiating the application by providing a user with a copy of the initial document template, the instantiating yielding an instantiated document; a module for allowing the user to interact with the instantiated document; a module for performing a check for updates of the application; a module for updating the application if the currently instantiated document application version is not a latest available version of the application, the module for updating being configured to: obtain a latest version of the initial document template, obtain a transformation description for converting end-user data in the instantiated document to an updated schema format, if an end-user data schema of the application has been changed, create a newly instantiated document on the latest version of the initial document template, transform the end-user data using the transformation description if one was given, placing the end-user data or transformed end-user data into the newly instantiated document, and replace the instantiated document with the new instantiated document in the end-user experience.

A third aspect of the present invention provides a computer readable medium containing a program product for preserving a state of an application during update, the computer readable medium comprising program code for causing a computer system to: provide an initial document template tagged by a name and a version number to represent an initial state of the application; instantiate the application by providing a user with a copy of the initial document template, the instantiating yielding an instantiated document; allow the user to interact with the instantiated document; perform a check for updates of the application; update the application if the currently instantiated document application version is not a latest available version of the application, as follows: obtain a latest version of the initial document template, obtain a transformation description for converting end-user data in the instantiated document to an updated schema format, if an end-user data schema of the application has been changed, create a newly instantiated document on the latest version of the initial document template, transform the end-user data using the transformation description if one was given, placing the end-user data or transformed end-user data into the newly instantiated document, and replace the instantiated document with the new instantiated document in the end-user experience.

A fourth aspect of the present invention provides a method for deploying an application for preserving a state of an application during update, comprising: providing a computer infrastructure being operable to: provide an initial document template tagged by a name and version number to represent an initial state of the application; instantiate the application by providing a user with a copy of the initial document template, the instantiating yielding an instantiated document; allow the user to interact with the instantiated document; perform a check for updates of the application; update the application if the currently instantiated document application version is not a latest available version of the application, as follows: obtain a latest version of the initial document template, obtain a transformation description for converting end-user data in the instantiated document to an updated schema format, if an end-user data schema of the application has been changed, create a newly instantiated document on the latest version of the initial document template, transform the end-user data using the transformation description if one was given, placing the end-user data or transformed end-user data into the newly instantiated document, and replace the instantiated document with the new instantiated document in the end-user experience.

A fifth aspect of the present invention provides a data processing system for preserving a state of an application during update, comprising: a memory medium having instructions; a bus coupled to the memory medium; and a processor coupled to the bus that when executing the instructions comprises: provide an initial document template tagged by a name and a version number to represent an initial state of the application; instantiate the application by providing a user with a copy of the initial document template, the instantiating yielding an instantiated document; allow the user to interact with the instantiated document; perform a check for updates of the application; update the application if the currently instantiated document application version is not a latest available version of the application, as follows: obtain a latest version of the initial document template, obtain a transformation description for converting end-user data in the instantiated document to an updated schema format, if an end-user data schema of the application has been changed, create a newly instantiated document on the latest version of the initial document template, transform the end-user data using the transformation description if one was given, placing the end-user data or transformed end-user data into the newly instantiated document, and replace the instantiated document with the new instantiated document in the end-user experience.

### BRIEF DESCRIPTION OF THE DRAWINGS

These and other features of this invention will be more readily understood from the following detailed description of the various aspects of the invention taken in conjunction with the accompanying drawings.

FIGS. 1 and 2 depict a method flow diagram according to an embodiment of the present invention.

FIG. 3 depicts a more specific computerized implementation according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following Sections:

I. General Description

II. Illustrative Embodiment

### I. General Description

As mentioned above, the present invention augments an application update with an automatic sequence of steps for instantiating the updated application in place of the currently running application without unintended loss of user-generated data that comprises part or all of the current application state. One advantage is that the end-user does not have to repeat a complex fill experience that has already been performed with a prior version of the same application. Particularly, when application updates involve better help information or business rules that are not applicable to the particular end-user, the requirement to repeat the fill experience is frustrating and therefore deemed intolerable from a user experience standpoint. Moreover, in some cases when business rules (e.g., data validation constraints or changes of schema) are applicable to the portion of application being consumed by the end-user, most if not all of the data supplied by the user is still relevant and simply causes the updated application to enter the most desirable state. For example, based on updated taxation rules, end-user data that was deemed sufficient in the earlier application may be incomplete in the new version of the application. The new version may consume most or all of the previously entered data to enter a state of needing a minimal amount of new information (which is different from being in the state of ready to submit).

In a typical embodiment, a client is provided an application that is to be updated from a server. However, this solution can be implemented in any type of environment and is not limited to a client-server environment.

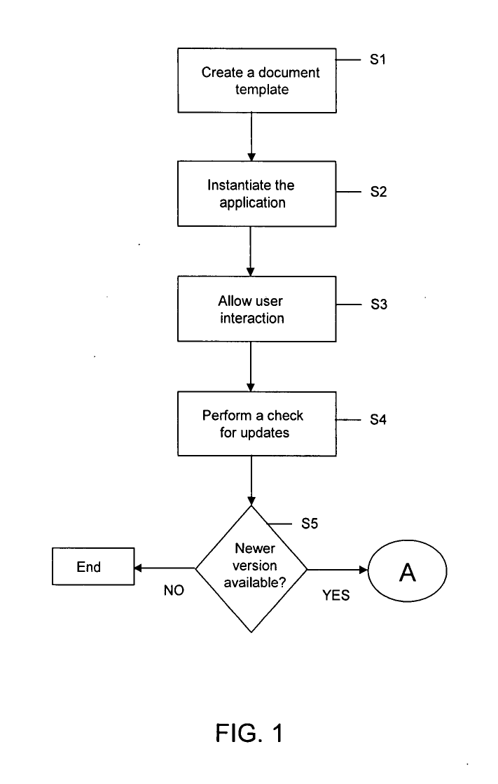

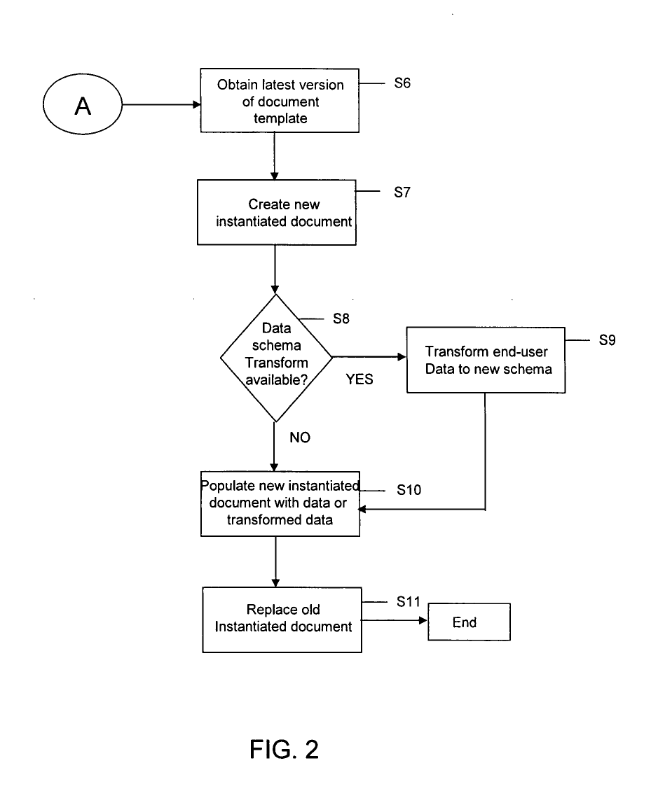

This methodology will now be described in conjunction with FIGS. 1 and 2. As shown, in step S1 a document template is created and tagged by name and version number to represent the initial state of the application. In step S2, the running application is instantiated by providing the end-user with a copy of the initial document template, which yields an instantiated document. In step S3, the user is permitted/allowed to interact with, make changes to, and possibly save and reload the instantiated document over a period of time. In step S4, a check for updates of the application is performed at a time in the document run-time that is specified either by the document run-time processor, the instantiated document, or both. Specified update times can include, for example, any start-up or reload of the instantiated document as well as attempts to perform a submission of the completed document for server-side transactional processing. In addition, the instantiated document or the document run-time processor run-time may contain information relevant to accessing the web service that contains the application's update information.

It step S5, it is determined if the currently instantiated document application version is the latest available version of the application. If it is the latest available version (NO, S5), the process ends. If it is not the latest available version (YES, S5), flow passes via “A” to step S6 with the latest version of the document template being obtained. In step S7, a new instantiated document is created. In step S8, it is determined if there is a transformation defined to convert data in the currently instantiated document to the data schema needed for the new instantiated document. If so, the transformation description for converting the instantiated document data to the updated schema format is used in step S9 to perform the transformation. In step S10, either the data from the currently instantiated document, or a transformation of the data, is used to populate the new instantiated document. In step S11, the new instantiated document replaces the currently instantiated document in the document run-time processor and becomes the basis of any further end-user interaction. It should be noted that these steps allow the bulk of implementation to occur either on the server-side or the client-side. However, for the sake of maximizing performance and scalability, it is advisable to perform as many of these steps as possible on the client-side.

### II. Computerized Implementation

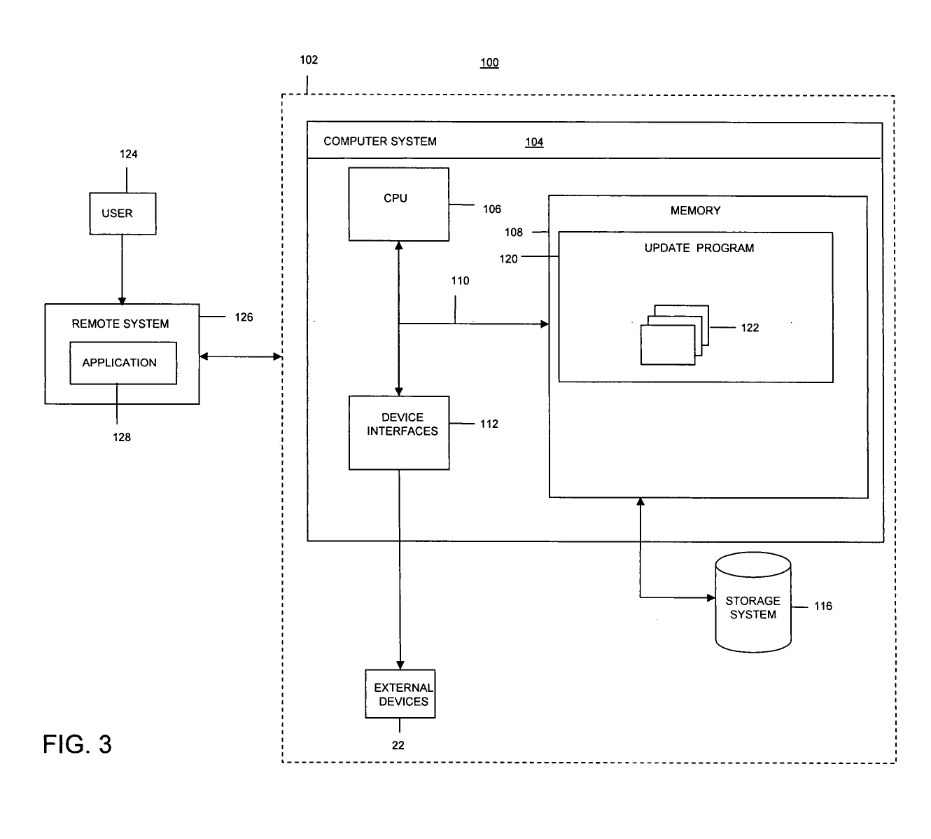

Referring now to FIG. 3, a computerized implementation 100 of an embodiment of the present invention is shown. As depicted, implementation 100 includes a computer system 104 deployed within a computer infrastructure 102. This is intended to demonstrate, among other things, that the present invention can be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity can be provided by conventional TCP/IP sockets-based protocol, and an Internet service provider can be used to establish connectivity to the Internet. Still yet, computer infrastructure 102 is intended to demonstrate that some or all of the components of implementation 100 can be deployed, managed, serviced, etc., by a service provider who offers to implement, deploy, and/or perform the functions of the present invention for others. In addition, although computer infrastructure 102 is depicted containing a single computer system 104, this need not be the case. Rather, computer infrastructure 102 can be implemented to include multiple computer systems.

As shown, computer system 104 includes a processing unit 106, a memory 108, a bus 110, and device interfaces 112. Further, computer system 104 is shown as including external devices 114 and a storage system 116. In general, processing unit 106 executes computer program code, such as update program 120, stored in memory 108 and/or storage system 116. While executing computer program code, processing unit 106 can read and/or write data to/from memory 108, storage system 116, and/or device interfaces 112. Bus 110 provides a communication link between each of the components in computer system 104. Although not shown, computer system 104 may also include I/O interfaces that communicate with: one or more external devices such as a cash broker, a keyboard, a pointing device, a display, etc.; one or more devices that enable a user to interact with computer system 104; and/or any devices (e.g., network card, modem, etc.) that enable computer system 104 to communicate with one or more other computing devices.

Computer infrastructure 102 is only illustrative of various types of computer infrastructures that can be used to implement the invention. For example, in one embodiment, computer infrastructure 102 comprises two or more computing devices (e.g., a server cluster) that communicate over a network to perform the various process of the invention. Moreover, computer system 104 is only representative of various possible computer systems that can include numerous combinations of hardware. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, device interfaces 112 can comprise any module for exchanging information with one or more external device 114. Still further, it is understood that one or more additional components (e.g., system software, math co-processing unit, etc.) not shown in FIG. 2 can be included in computer system 104.

Storage system 116 can be any type of system capable of providing storage for information under the present invention. To this extent, storage system 116 may include one or more storage devices, such as a magnetic disk drive or an optical disk drive. In another embodiment, storage system 116 includes data distributed across, for example, a local area network (LAN), wide area network (WAN) or a storage area network (SAN) (not shown). In addition, although not shown, additional components, such as cache memory, communication systems, system software, etc., may be incorporated into computer system 104.

Shown in memory 108 of computer system 104 is update program 120, which includes a set (at least one) of modules 122. The modules 122 generally provide the functions of the present invention as described and claimed herein. For example, modules 122 of update program 120 allow an application 128 provided or otherwise loaded on a remote system 126 to be updated in a fashion that prevents loss of any data input by user 124. This includes the transformation of data using transformation descriptions, and populating the results into a newly instantiated document, which will replace a previous instantiated document.

While shown and described herein as a solution for preserving a state of an application during update, it is understood that the invention further provides various alternative embodiments. For example, in one embodiment, the invention provides a computer-readable/useable medium that includes computer program code to enable a computer infrastructure to provide mobile web service brokering. To this extent, the computer-readable/useable medium includes program code that implements each of the various processes of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 and/or storage system 116 (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, can offer to provide preservation of a state of an application during update. In this case, the service provider can create, maintain, and support, etc., a computer infrastructure, such as computer infrastructure 102 that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for preserving a state of an application during update. In this case, a computer infrastructure, such as computer infrastructure 102, can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 104, from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic device system/driver for a particular computing and/or processing device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or device devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for preserving a state of an application during update, comprising:
providing an initial document template tagged by a name and a version number to represent an initial state of the application;
instantiating the application by providing a user with a copy of the initial document template, the instantiating yielding an instantiated document;
allowing the user to interact with the instantiated document;
performing a check for updates of the application; and
updating the application if the currently instantiated document application version is not a latest available version of the application, as follows:
obtaining a latest version of the initial document template:
obtaining a transformation description for converting end-user data in the instantiated document to an updated schema format, if an end-user data schema of the application has been changed,
creating a newly instantiated document on the latest version of the initial document template for the application,
transforming the end-user data using the transformation description if one was given, placing the end-user data or transformed end-user data into the newly instantiated document, and
replacing the instantiated document for the application with the new instantiated document for the application in the end-user experience.

2. The method of claim 1, the performing comprising performing the check for the updates at times in a document run time that are specified by at least one of a document run-time processor and the instantiated document.

3. The method of claim 2, the instantiated document or the document run-time processor run-time being capable of containing information relevant to accessing a web service that contains update information for the application.

4. The method of claim 2, the times comprising at least one of any start-up or reloading of the instantiated document, and selected attempts to perform a submission of the instantiated document to the server-side for transactional processing.

5. A system for preserving a state of an application during update, comprising:
providing an initial document template tagged by a name and a version number to represent an initial state of the application;
a module for instantiating the application by providing a user with a copy of the initial document template, the instantiating yielding an instantiated document;
a module for allowing the user to interact with the instantiated document;
a module for performing a check for updates of the application;
a module for updating the application if the currently instantiated document application version is not a latest available version of the application, the module for updating being configured to:
obtain a latest version of the initial document template,
obtain a transformation description for converting end-user data in the instantiated document to an updated schema format, if an end-user data schema of the application has been changed,
create a newly instantiated document on the latest version of the initial document template for the application,
transform the end-user data using the transformation description if one was given, placing the end-user data or transformed end-user data into the newly instantiated document, and
replace the instantiated document for the application with the new instantiated document for the application in the end-user experience.

6. The system of claim 5, the module for performing being configured to perform the check for the updates at times in a document run time that are specified by at least one of a document run-time processor and the instantiated document.

7. The system of claim 6, the instantiated document or the document run-time processor run-time being capable of containing information relevant to accessing a web service that contains update information for the application.

8. The system of claim 6, the times comprising at least one of any start-up or reloading of the instantiated document, and selected attempts to perform a submission of the instantiated document to the server-side for transactional processing.

9. A computer readable medium containing a program product for preserving a state of an application during update, the computer readable medium comprising program code for causing a computer system to:
provide an initial document template tagged by a name and a version number to represent an initial state of the application;
instantiate the application by providing a user with a copy of the initial document template, the instantiating yielding an instantiated document;
allow the user to interact with the instantiated document;
perform a check for updates of the application;
update the application if the currently instantiated document application version is not a latest available version of the application, as follows:
obtain a latest version of the initial document template,
obtain a transformation description for converting end-user data in the instantiated document to an updated schema format, if an end-user data schema of the application has been changed,
create a newly instantiated document on the latest version of the initial document template for the application,
transform the end-user data using the transformation description if one was given, placing the end-user data or transformed end-user data into the newly instantiated document, and
replace the instantiated document for the application with the new instantiated document for the application in the end-user experience.

10. The computer readable medium of claim 9, further comprising program code for causing the computer system to perform the check for the updates at times in a document run time that are specified by at least one of a document run-time processor and the instantiated document.

11. The computer readable medium of claim 10, the instantiated document or the document run-time processor run-time being capable of containing information relevant to accessing a web service that contains update information for the application.

12. The computer readable medium of claim 10, the times comprising at least one of any start-up or reloading of the instantiated document, and selected attempts to perform a submission of the instantiated document to the server-side for transactional processing.

13. A method for deploying an application for preserving a state of an application during update, comprising:
providing a computer infrastructure being operable to:
provide an initial document template tagged by a name and a version number to represent an initial state of the application;
instantiate the application by providing a user with a copy of the initial document template, the instantiating yielding an instantiated document;
allow the user to interact with the instantiated document;
perform a check for updates of the application;
update the application if the currently instantiated document application version is not a latest available version of the application, as follows:
obtain a latest version of the initial document template,
obtain a transformation description for converting end-user data in the instantiated document to an updated schema format, if an end-user data schema of the application has been changed,
create a newly instantiated document on the latest version of the initial document template for the application,
transform the end-user data using the transformation description if one was given, placing the end-user data or transformed end-user data into the newly instantiated document, and
replace the instantiated document for the application with the new instantiated document for the application in the end-user experience.

14. The method of claim 13, the computer infrastructure being further operable to perform the check for the updates at times in a document run time that are specified by at least one of a document run-time processor and the instantiated document.

15. The method 14, the instantiated document or the document run-time processor run-time being capable of containing information relevant to accessing a web service that contains update information for the application.

16. The method of claim 14, the times comprising at least one of any start-up or reloading of the instantiated document, and selected attempts to perform a submission of the instantiated document to the server-side for transactional processing.
